(19) United States
(12) Patent Application Publication
(10) Pub. No.: US 2024/0424976 A1
(43) Pub. Date: Dec. 26, 2024

(54) TIE DOWN ASSEMBLY

(71) Applicant: Michael C. Kelly, Franklin, MA (US)

(72) Inventor: Michael C. Kelly, Franklin, MA (US)

(21) Appl. No.: 18/212,930

(22) Filed: Jun. 22, 2023

(51) Int. Cl. B60P 7/08

(52) U.S. Cl. CPC B60P 7/083; B60P 7/0846

(57) ABSTRACT

Apparatus are provided that comprise a tie down assembly. The assembly includes a flexible elongated line, at least one terminal connector, and a rotating line adjustment mechanism. In one embodiment, the rotating line adjustment mechanism includes a spiral return spring supported by and fixed to the housing and having a retraction portion fixed to the line whereby the retraction portion pulls and thereby shortens the line.

### FIELD OF THE DISCLOSURE

Aspects of the present disclosure relate to apparatus for tying one or more items to a support structure. Other aspects relate to a tie down assembly for tying one or more ladders to a rack on a vehicle.

### BACKGROUND OF THE DISCLOSURE

Existing tie assemblies are problematic. For example, FIGS. 1 and 2 show a prior art rubber bungee cord. In FIG. 1, the bungee cord is in good condition, but the cord shown in FIG. 2 has been damaged during normal use by the weather and sun such that its structure is less reliable and may break. Other types of existing ratchet tie assemblies use nylon cords that are less susceptible to weather damage, but they are difficult to use.

### SUMMARY OF THE DISCLOSURE

There is a need for an improved tie down assembly and apparatus that is less susceptible to damage from weather and sun, and at the same time easy to use. For example, there is a need for an improved assembly that requires less time when securing a ladder to a rack on a vehicle. Embodiments of the invention are directed to a method, apparatus, or any subcomponent or subcombination thereof, as described herein. Per one embodiment, apparatus is/are provided that comprise a tie down assembly. The assembly includes a flexible elongated line, at least one terminal connector, and a rotating line adjustment mechanism. A housing is secured to and enclosed around at least a portion of the line. In one embodiment, the rotating line adjustment mechanism includes a spiral return spring supported by and fixed to the housing, and having a spring-biased retraction portion fixed to the line whereby the retraction portion pulls and thereby shortens the line.

### DESCRIPTION OF THE DRAWINGS

Example embodiments will be described with reference to the following drawings, in which:

FIG. 1 is a perspective view of a prior art rubber bungee tie down cord with terminal S hooks;

FIG. 2 is section of a prior art rubber bungee tie down cord with sun and weather damage;

FIG. 3 is a perspective of a utility van with a roof rack and a ladder on top of the rack tied down with an embodiment tie down assembly;

FIG. 4 is a perspective view of an embodiment of a tie down assembly;

FIG. 5 is an elevated front view of ratchet, pawl, and coil spring components;

FIG. 6 is a perspective view of a spool structure;

FIGS. 7A-7D are schematic depictions of an embodiment where two extendable portions of the cord are secured to the spool and coil spring at one common point;

FIG. 8A is a front schematic view of one embodiment of a tie down device where one extendable cord is secured to a spool and coil spring and another extendable cord is attached and partially housed within a stow away chamber;

FIG. 8B is a front schematic view of an embodiment of a tie down device, depicting two extendable cords attached to separate spool and coil spring structures and also depicting one embodiment of a mount structure;

FIG. 8C is a front schematic view of a tie down device, showing another embodiment of a mount structure for mounting the tie down device to a structure;

FIG. 9A is a partial end view of a slidable lock; and

FIG. 9B is a partial perspective view of the slidable lock shown in FIG. 9A.

### DETAILED DESCRIPTION

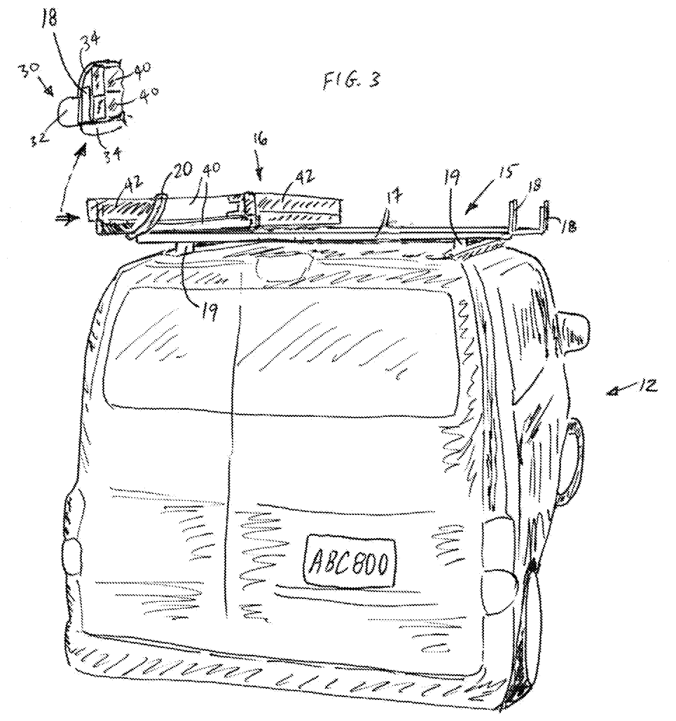

Referring now to the drawings in greater detail, FIG. 3 shows a utility van 12 with a roof rack 15, holding a ladder 16. The illustrated ladder 16 is laid horizontally on top of cross bars 17 held up and secured to the vehicle roof by a set of towers/feet 19, and positioned along the left abutting vertical end supports 18. As shown in the upper left corner of the drawing, in a cutaway end view of a portion of the ladder and roof rack, an embodiment of a tie assembly 30 is provided that includes a housing 32 and a cord 34, among other elements not visible in the drawing. Cord 34 in this embodiment is a 1 inch wide nylon strap, and it is wrapped around a combination of two left-side rails 42 and a pair of rungs 40.

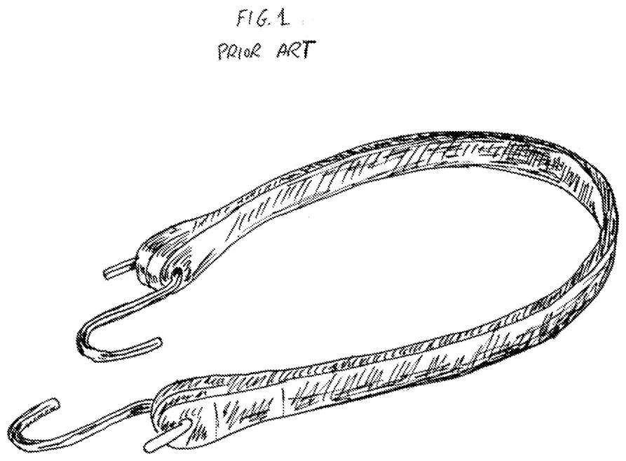

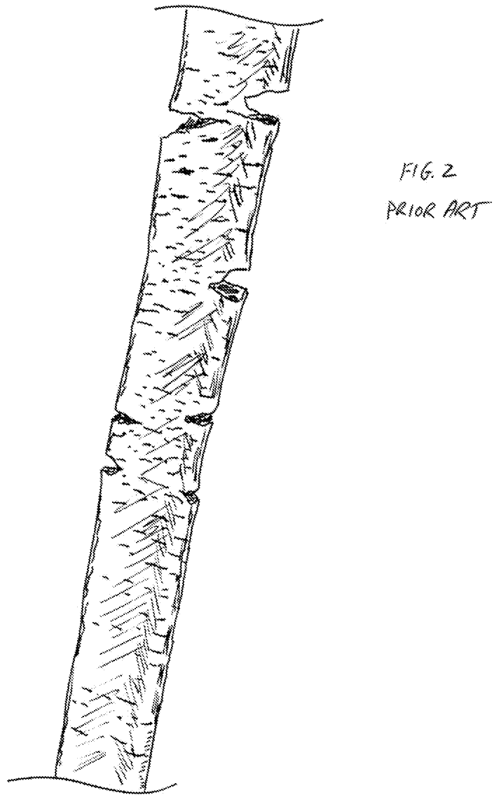

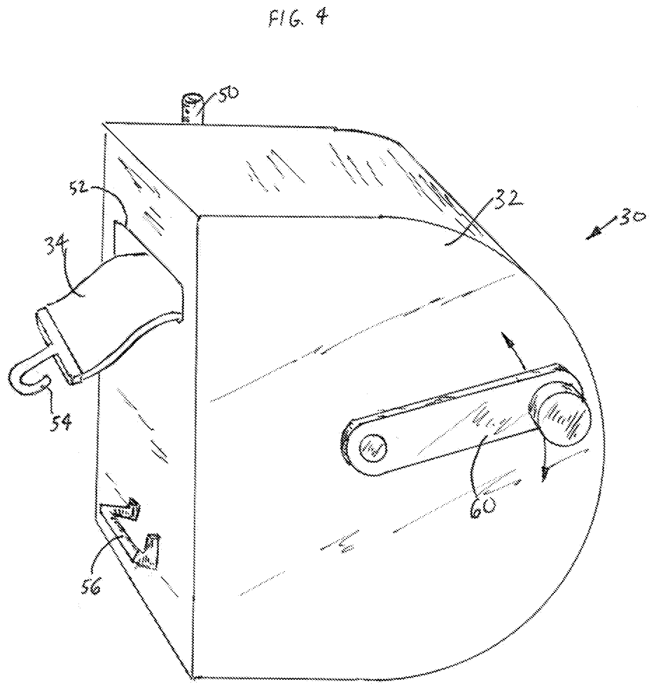

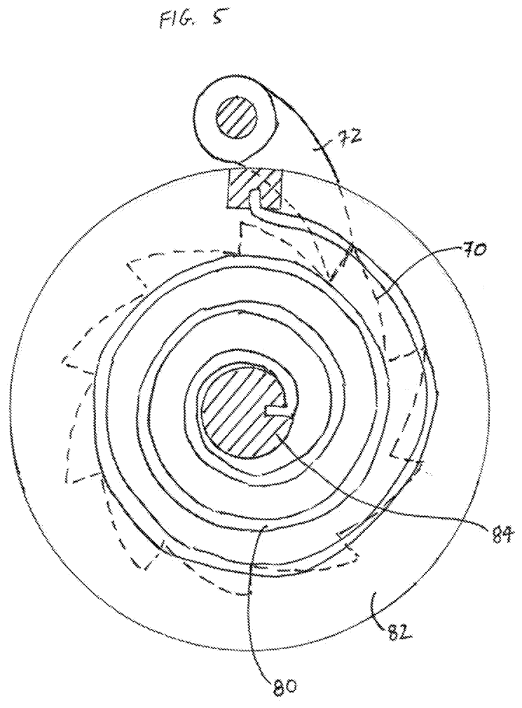

FIG. 4 provides a perspective view of the tie assembly 30 shown in FIG. 1. A housing 32 is provided that is secured to and enclosed around a line 34. Housing 32 contains (not shown in FIG. 4) a rotating line adjustment mechanism that includes spiral return spring and ratchet and pawl mechanisms (see FIG. 5). A pawl release member 50 is provided on the upper back side of the housing 32. Line 34 is shown exiting an opening 52. A hook type terminal connector 54 is secured to a terminal end of line 34. When line 34 is wrapped around and securing a ladder, as shown in FIG. 3 for example, hook type terminal connector 54 is hooked into an eye type mate 56 that is secured to or integral with housing 32. Other types of connectors could be used in other embodiments, instead of hook type terminal connector 54 and eye type mate 56. For example, they could both be hook type connectors, or terminal connector 54 could be an eye type connector while mate 56 is a hook.

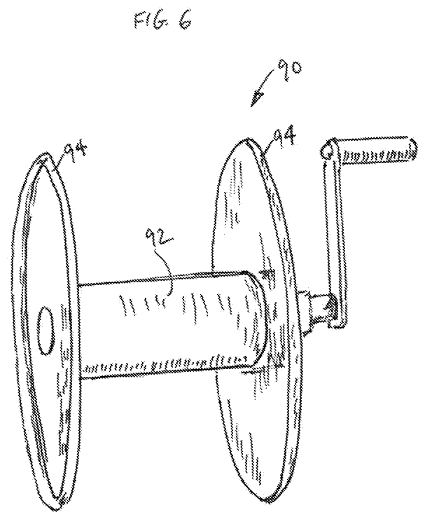

A reel handle 60 is shown, which is connected to an internal assembly of a ratchet and pawl, a spiral spring, and a spool (See FIGS. 5 and 6 and description below regarding the same). Alternatively, reel handle 60 could be provided on the opposite side of the housing. Per another embodiment, a reel handle might not be provided, and the spiral spring, operable to draw the line in when the pawl 50 is released using pawl release member 50 (as further explained below), can serve to tighten and shorten line 34 around the objects being secured—for example, a ladder 16 as shown in FIG. 3. Per yet another embodiment, reel handle and a spool rotatably holding the line, may be provided without accompanying coil spring and/or without the accompanying ratchet and pawl. In this example, the line could be reeled in, and secured by activating an added lock mechanism (not shown) to hold the spool in position once in its desired position.

As explained above, line 34 in the illustrated embodiment is a synthetic braided nylon strap. More specifically, in one example embodiment, the strap has a breaking strength of over 3000 pounds. Alternatively, line 34 could be a rope, which could be made of twisted strands of a natural or synthetic fiber or a composite of plural natural and/or synthetic fibers. The line 34 in the embodiment is a single continuous line. Per other embodiments, line 34 could be an assembly of plural lines connected in series forming sections of a composite line. As described in more detail below, one or plural lines may be provided, and the line may be a stretchable elastic cord or a non stretch/non-elastic cord. In some embodiments, a given line may be stretchable in one section and non-stretch in another section.

Depending on the embodiment, a line or section of a line may be made of rubber or an EPDM synthetic or natural rubber. A given line may be provided with a protective sheathing. The sheathing may or may not be configured to be stretchable. The sheathing may be a braided material made, for example, from nylon, polypropylene, polyester and/or cotton.

FIG. 5 is an elevated front view of a ratchet 70 and pawl 72, and a coil spring 80. The illustrated coil spring 80 connects at one end to rotatable disk 82, and at the other end to a stationary arbor 84. Disk 82 may be one side of a spindle structure (see, e.g., FIG. 6), or coupled to a side of a spindle which will rotate with the disk as line 34 is elongated or shortened. When paul release member 50 (shown in FIG. 4) is activated, paul 72 is rotated counterclockwise and thereby releases coil spring 80 (and the attached spool) to allow it to rotate counterclockwise in a tightening direction which allows the line to elongate. When paul 72 is engaged, further elongation of the line is not allowed. The paul and ratchet mechanism will allow clockwise movement of coil spring 80, which will result in shortening and tightening of the line. This can be facilitated with the aid of reel handle 60, although the force of coil spring 80 will also provide a tightening force on the line.

FIG. 6 shows a spool structure 90 comprising a spindle 92 and two containing disk shape walls 94. The line is secured to and wrapped around spindle 92 as the spindle is rotated in a winding direction which corresponds to clockwise in FIG. 5.

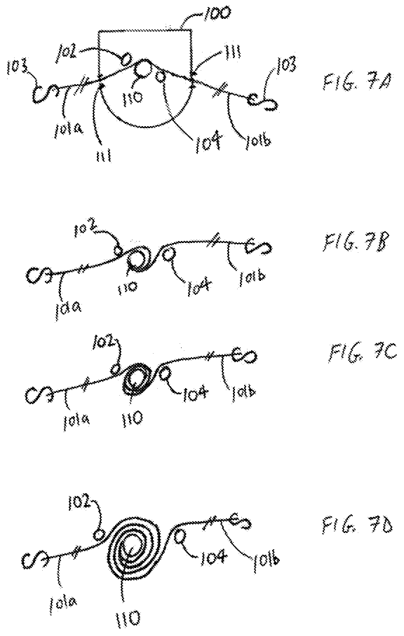

FIGS. 7A-7D are schematic depictions of several positions of an embodiment where two extendable portions of the cord 101a, 101b are secured to a spindle 110 at one common point. The cord is shown in various stages of winding, with FIG. 7A showing the cord sections in a fully unwinded state, and FIGS. 7B, 7C, and 7D in incrementally increased winded states. Pairs of lines intersecting each section of cord 101a and 101b represent that the actual extended length of cord sections 101a and 101b are not as shown. For example, the extended lengths of the cord sections in FIG. 7A are longer than they are in FIG. 7B, which are longer than they are in FIGS. 7C and 7D respectively.

In this example, spindle 110 may form part of an assembly including a reel, a ratchet and paul, and a spring-biased retraction mechanism. Alternatively, a reel and position lock may be secured to a spindle without a ratchet and paul and without a spring-biased retraction mechanism. In another example, a reel and coil spring may be provided with a position lock in lieu of a ratchet and paul. Other structures (not shown) that allow the spindle to be rotated (to wind/unwind and shorten/lengthen the cord) may also be employed.

A housing outline 100 is shown in FIG. 7A to provide an example of a cord configuration in the illustrated embodiments. The illustrated housing 100, which may also be the same although not specifically shown in FIGS. 7B-7D, has cord openings 111 on side portions of the housing. In the embodiment shown in FIG. 4 with one cord section, a cord opening 52 is provided. In other embodiments not shown, one or more cord openings may be provided in different locations.

In the example shown in FIGS. 7A-7D, cylindrical guide posts 102, 104 are provided to help guide the path of each section of the cord 101a, 101b. One guide post is provided on each side. Alternatively, pairs of sandwiching posts may be provided. Guide posts 102, 104 may be configured to be stationary or to roll. In the illustrated embodiment, each terminal end has an S hook type terminal connector 103. In other embodiments, other types of terminal connectors may be provided. It is preferred in this example, that terminal connectors 103 be able to mate and secure to each other, so cords 101a, 101b. when extended and wrapped around a secured item and supporting structure (one or more ladders and a roof rack in one example), can be tightly linked to each other. With S hooks, for example, one hook may be hooked onto the other, and the tie assembly thereby can be tightly wrapped around a secured item and a supporting structure by winding the cord and locking it in the wound position.

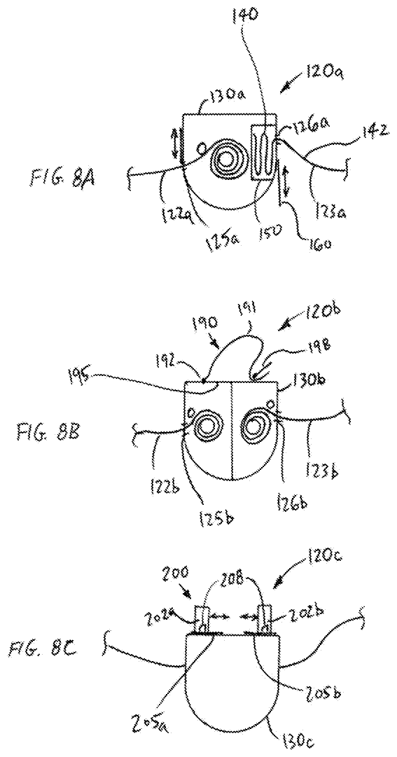

FIG. 8A is a front schematic view of one embodiment of a tie down device 120a with two independent cord sections in separate chambers. Each cord section 122a, 123a exits a different opening 125, 126 in a different part of housing 130a (in opposite side portions in the illustrated embodiment). One non stretch extendable cord 122a is secured to a windable spool (connected to a coil spring in one embodiment), and another stretchable/elastic extendable cord 123a is attached and partially housed within a stow away chamber.

Cord section 123a may alternatively also be non stretch throughout its entire length. In the example embodiment shown, however, cord section 123a includes an inner section 140 and an outer section 142. Inner section 140 is configured to be stretchable, and is therefore made of an elastic material for example of the type described hereinabove. Inner section 140 may have a stretchable outer sheath. Inner section 140 is configured so that it may be tucked entirely into stow away chamber 150. This embodiment with a stretchable section allows a person to more easily extent cord section 123a when its elastic section is extendable and stretchable outside of chamber 150. This makes it easier to insert and manipulate the two opposite cord sections, connect each of their terminal ends (not shown) to a support structure (e.g., part of a roof rack or vehicle) or to each other, once the opposite cord sections have been put in an optimum securing position (e.g., wrapped around rungs and rails of a ladder and connected with respective terminal connectors (e.g. S hooks) to a vertical end support 18 as shown in FIG. 3). After the cord sections have been optimally positioned, the inner stretchable section of the second cord section can be tucked into stowaway chamber 150 and tightly secured therein by slidably closing a lock 160. Stow away chamber 150 protects the enclosed cord section from the weather and from sun exposure.

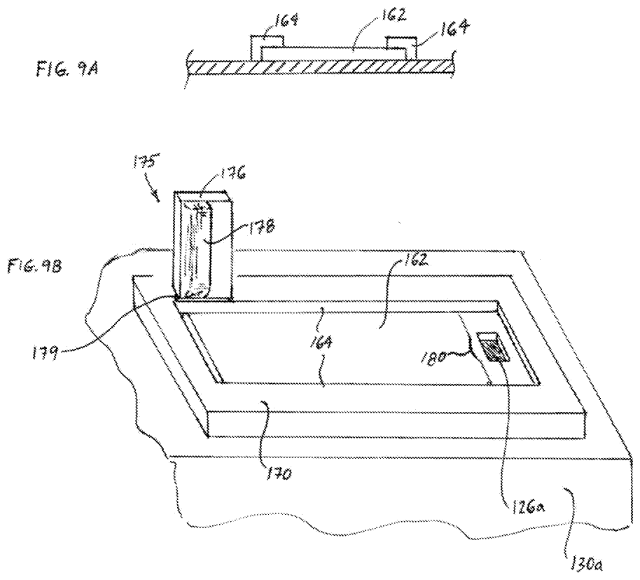

Lock 160 may have a sheet member 162, e.g., rectangular in shape, held in place with lip or flange type channels 164, as shown in FIGS. 9A and 9B. FIG. 9A shows a partial cutaway view of a side of housing side 130a, an end of sheet member 162, and lips 164.

FIG. 9B shows pertinent portions of the sheet and lip structure and a portion of housing 130a, in a perspective view. A hinged securing member 175 is connected via a hinge 179 to one end of a frame 170 formed by lips 164. Sheet member 162 is slidably moveable toward and away from cord opening 126a. When sheet member 162 is in a position where it abuts the cord at opening 126a, hinged securing member 175 can be rotatably closed. A snapping lip 176 is provided at an end of securing member 175, which engages with a mating portion 177 to releasably lock securing member 175 in a closed position. Securing member 175 has a protruding ridge portion 178 with an edge 185 that aligns with the end of sheet member 162 when it is slid into its closed/locking position towards cord opening 126a. Edge 185 when engaged with the end of sheet member 162 provides a barrier and prevents the sheet member from being slid open and thereby unlocked. At the far end of sheet member 162, near cord opening 126a, a curved interface/locking portion 180 is provided. Portion 180 may be configured to have a dull serrated edge that fully secures the cord in its position. In addition, or alternatively, cord may be provided with one or more larger dimension knot like joints that help secure the cord in position, underneath and against locking portion 180 and against the confines of opening 126a further narrowed by the locked position of sheet member 162 and its locking portion 180.

FIG. 8B is a front schematic view of an embodiment of a tie down device 120b, depicting two extendable cords 122b, 123b attached to separate spool and coil spring structures, and also depicting a mount assembly 190. The illustrated mount assembly 190 includes a strap 191 secured at one of its ends with an anchor 192 provided at or toward one side of an interfacing surface 195 of housing 130b. A hinged cam lock lever 198 is provided at or toward another side of interfacing surface 195. Strap 191 may be removably inserted into a slot provided in cam lock lever 198, and its length can be adjusted into a desired position and locked in place by closing lever 198 (in a clockwise direction in the figure, per one embodiment).

In operation, housing 130b may be directly supported with a person's hand, indirectly by the person holding one or both cords 122b and 123b, or by securing interfacing surface 195 to a support structure using mount assembly 190. One may first secure housing to a support structure, and thereafter connect terminal connectors at terminal ends of the cords to each other or to suitable portions of a support structure to which the mount item (e.g., one or more ladders) is being attached. The terminal connectors may also be mated to each other, e.g., if S hooks or other suitable connectors are employed. Alternatively, the terminal connectors may be first secured to a support structure, and thereafter, housing 130b may be secured by holding interfacing surface 195 against a suitable portion of the support structure and securing the housing in place using mount assembly 190. For example, the tie down assembly housing may be mounted (with the mount assembly) to a fixed portion of a ladder, to a roof support structure, to a fixed location on a vehicle roof rack, to a cross bar of a roof rack, to a longitudinal support of a roof rack, to a tower/foot of a roof rack, and/or to a vertical end support.

FIG. 8C is a front schematic view of a tie down device, showing another embodiment of a tie down device 120c with another type of mount structure 200 for mounting the tie down device to a structure. In operation, the tie down device shown in FIG. 8C may be used as described above with reference to the structures in FIG. 8B.

The mount structure 200 shown in FIG. 8C includes a pair of grip members 202a, 202b. Grip members 202a, 202b are held by slidable support channels 205a and 205b respectively. Each of support channels 205a and 205b allows for grip members 202a, 202b to be moved in the direction of the arrows in the figure. A cam-activated lock lever 208 is provided one one or the other of each support channel and each grip member, and is configured to be releasably engaged to secure the positions of the grip members in relation to their position along the paths of the slidable support channels. Grip members 202a and 202b may be provided, on their inners sides that face each other, with a textured surface to increase friction and gripping when those sides are engaged with a support structure. The textured surface may further be a different material with increased gripping function. e.g., rubber or synthetic rubber.

In the various embodiments herein, the housing, moveable components contained therein, and other structures may be made of a metal of sufficient strength and durability, such as steel, a steel alloy, an aluminum alloy, or a reinforced nylon, to name some examples.

The claims, as originally presented and as they may be amended, encompass variations, alternatives, modifications, improvements, equivalents, and substantial equivalents of the embodiments and teachings disclosed herein, including those that are presently unforeseen or unappreciated.

What is claimed is:

1. Apparatus comprising a tie down assembly, the assembly including:
a flexible elongated line;
at least one terminal connector fixed to a terminal end of the line;
a housing secured to and enclosed around at least a portion of the line; and
a rotating line adjustment mechanism configured to adjust the length of the line, wherein the rotating line adjustment mechanism includes a spiral return spring supported by and fixed to the housing and having a spring-biased retraction portion fixed to the line whereby the spring-biased retraction portion pulls and thereby shortens the line.

2. The apparatus according to claim 1, further comprising a mount configured to secure and support the tie down assembly to a structure on a vehicle.

3. The apparatus according to claim 2, wherein the mount is configured to secure and support the tie down assembly to a fixed location on a portion of a ladder provided on top of a vehicle.

4. The apparatus according to claim 2, wherein the mount is configured to secure and support the tie down assembly to a fixed location on a vehicle roof rack.

5. The apparatus according to claim 2, wherein the mount comprises a clamp.

6. The apparatus according to claim 2, wherein the mount comprises a strap.

7. The apparatus according to claim 1, wherein the line comprises a rope.

8. The apparatus according to claim 1, wherein the line comprises a strap on a spool secured to the retraction portion.

9. The apparatus according to claim 1, wherein at least one or more portions of the line are an elastic cord.

10. The apparatus according to claim 1, wherein the line is a single continuous line.

11. The apparatus according to claim 1, wherein the terminal connector comprises a hook.

12. The apparatus according to claim 1, wherein the line includes a second terminal end and a second terminal connector fixed the second terminal end.

13. The apparatus according to claim 1, wherein the housing comprises a mate for securing the terminal connector to the housing.

14. The apparatus according to claim 1, further comprising a reel handle coupled to the rotating line adjustment mechanism and configured to allow manual rotation of the line adjustment mechanism to thereby wind the line.

15. Apparatus comprising:
a flexible elongated line;
at least one terminal connector fixed to a terminal end of the line;
a housing secured to and enclosed around at least a portion of the line; and
a rotating line adjustment mechanism configured to adjust the length of the line, wherein the rotating line adjustment mechanism includes a reel and a reel handle connected to the reel, whereby manual rotation of the reel handle pulls and thereby shortens the line.

16. The apparatus according to claim 15, further comprising a mount configured to secure and support the housing to a structure on a vehicle.

17. The apparatus according to claim 16, wherein the mount is configured to secure and support the housing to a fixed location on a portion of a ladder provided on top of a vehicle.

18. The apparatus according to claim 16, wherein the mount is configured to secure and support the housing to a fixed location on a vehicle roof rack.

19. The apparatus according to claim 16, wherein the mount comprises a clamp.

20. The apparatus according to claim 16, wherein the mount comprises a strap.
